(19) United States
(12) Patent Application Publication
(10) Pub. No.: US 2014/0053085 A1
(43) Pub. Date: Feb. 20, 2014

(54) METHODS AND SYSTEMS FOR COLLABORATIVE BROWSING

(71) Applicant: Calgary Scientific Inc., Calgary (CA)

(72) Inventors: Matthew James Stephure, Calgary (CA); Sam Anthony Leitch, Calgary (CA); Christopher James Garrett, Calgary (CA)

(73) Assignee: Calgary Scientific Inc., Calgary (CA)

(21) Appl. No.: 13/968,245

(22) Filed: Aug. 15, 2013

Related U.S. Application Data
(60) Provisional application No. 61/683,346, filed on Aug. 15, 2012.
(60) Provisional application No. 61/683,337, filed on Aug. 15, 2012.

(51) Int. Cl. H04L 12/24

(52) U.S. Cl. CPC H04L 41/0253
USPC 715/753

(57) ABSTRACT

Systems and methods for providing a collaborative browsing capability. A web browser service may be collaboratively browsed by plural client computing devices at an enumerated URL in a collaborative browsing (co-browsing) session. A request made by a web browser in the session may be intercepted by a co-browsing service and forwarded to the web browser service. A response to the request is received by the co-browsing service and communicated all web browsers participating in the co-browsing session. For configured web browsers, a view associated with web browser service may be translated into client computing device specific presentation data for display.

### CROSS-REFERENCE TO RELATED APPLICATIONS

This disclosure claims priority to U.S. Provision Patent Application No. 61/683,337, filed Aug. 15, 2012, entitled “METHODS AND SYSTEMS FOR COLLABORATIVE BROWSING AND REMOTE APPLICATION SHARING;” and U.S. Provisional Application No. 61/683,346, filed Aug. 15, 2012, entitled “METHODS AND SYSTEMS FOR COLLABORATIVE REMOTE APPLICATION SHARING AND CONFERENCING WITH OPTIONAL CO-BROWSING.” Each of the disclosures of the above-noted applications is incorporated herein by reference in its entirety.

### BACKGROUND

In collaborative browsing (co-browsing) sessions, it is common that one participant browses page(s) on a site using a first web browser, while other participants view the same page(s) on their own web browsers. As such, joint navigation of the site is possible. Typically, this is accomplished using client-side software or plug-ins that are installed on each client device participating in the co-browsing session. Often, one participant acts a host and performs the navigation, whereas the other participants are guests and merely view the host's navigation. As such the functionality is limited. In addition, co-browsing is difficult to implement due to the essential confidence requirements to share any real-time experience, and strong resistance provided by OS and browser security mechanisms. Co-browsing technology has many inherent challenges such as page personalizations or sites that require user authentication.

### SUMMARY

Disclosed herein are systems and methods for providing a fully interactive collaborative browsing (co-browsing) capability, and which displays web content in a method that conforms to the form factor and conventions of each participating computing device and web browser. In accordance with some implementations, there is provided a method for collaborative browsing within a session. The method may include receiving a connection to the web browser service from a first client device; receiving an indication to begin a co-browsing session, the co-browsing session including at least the web browser service, the first client device and at least one second client device; receiving connections to the web browser service from the first client device and the at least one second client device, the connections being made to the web browser service at an enumerated Uniform Resource Locator (URL) associated with the remote server; receiving, at a co-browsing service executing on the remote server, a request made to the web browser service from one of the first client device and the at least one second client device; sending the request from the co-browsing service to the web browser service; receiving, at the co-browsing service, a response to the request from the web browser service; and communicating the response from the co-browsing service to each of the first client device and the at least one second client device.

In accordance with some implementations, there is provided at method of collaborative browsing of a web browser service by a plurality of web browsers in a collaborative browsing session, each of the plurality of web browsers being associated with a respective client device. The method may include executing a co-browsing service on a remote access server; receiving, at the co-browsing service, a request for a resource associated with the web browser service, the request being made from at least one web browser of the plurality of web browsers in the collaborative browsing session and being communicated to a URL of the co-browsing service; forwarding the request from the collaborative browsing session to the web browser service; receiving, at the co-browsing service, a response from the web browser service, the response including the resource; and synchronizing, using the co-browsing service, a view of the web browser service at each of the plurality of web browsers such that each of the plurality of web browsers displays substantially a same view of the web browser service.

In accordance with yet other implementations, there is provided a method of establishing a co-browsing session to a web browser service using a co-browsing service executing on a remote access server. The method may include receiving, at an enumerated uniform resource locator (URL) of the co-browsing service, a connection from plural client computing devices to the web browser service; proxying, by a co-browsing proxy of the co-browsing service, a request made to the web browser service by one of the client computing devices; sending the proxied request from the co-browsing service to the web browser service; receiving a response to the proxied request from the web browser service at the co-browsing service; and communicating the response to each of the plural client computing devices.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagram illustrating a system for providing collaborative browsing (co-browsing) via a computer network to a web browser service executing on an application server;

FIGS. 2A and 2B illustrate a block diagram of exemplary data communication transferred between components in accordance with implementations of the present disclosure to provide for co-browsing;

FIG. 3 is an operational flow diagram of establishing a co-browsing session within the system of the present disclosure;

FIG. 4 is a state model in accordance with the present disclosure;

FIG. 5 illustrates additional aspects of the system of FIG. 1; and

FIG. 6 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

Collaborative browsing (co-browsing) according to the present disclosure enables participants in a session to browse and interact with the same web pages at the same time. The participants may be in different locations using, e.g., web browsers on different types of computing devices. Web pages visited or information entered by a participant is automatically synchronized to the computing devices of the other participants.

In furtherance of the above, the present disclosure provides methods and systems for co-browsing where a co-browsing service provides both a co-browsing proxy and a co-browsing translator such that multiple heterogeneous clients can be synchronized within the same session.

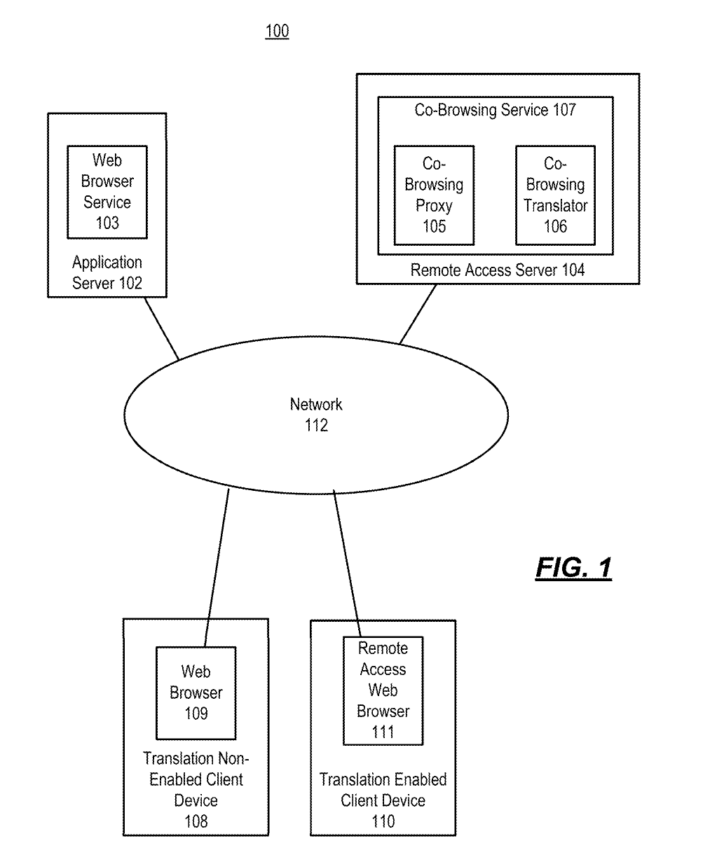

FIG. 1 is a simplified block diagram illustrating a system 100 for providing collaborative browsing (co-browsing) of a web browser service 103 executing on an application server 102 by client computing devices 108 and 110 via a network 112. In accordance with some implementations, the web browser service 103 may be, e.g., a web server application that is remotely accessed at an enumerated URL in a co-browsing session. For example, the web browser service 103 may be any web server, such as Apache, or Internet Information Services. From a web application within the web browser service 103, a participant in a co-browsing session may perform many functions, such as view pages on a web site, controlling a device on which the web browser service 103 is running (e.g., the application server 102), or controlling a peripheral device connected to the system (e.g., a printer or web camera). The web browser service 103 may also provide plug-in support for applications such as Flash or Silverlight.

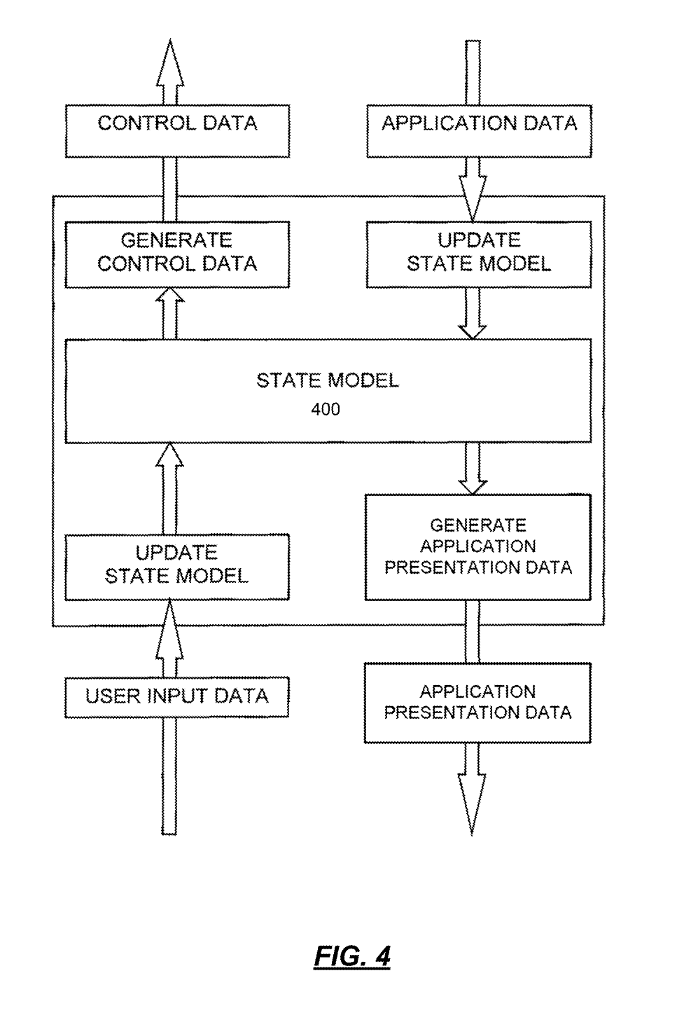

The system 100 comprises two or more client computing devices, which may be a translation non-enabled device 108 or a translation enabled device 110, or any combination thereof in accordance with type of browser that is executing on the device. The “translation” feature of the present disclosure is described below with regard to a co-browsing translator 106. Examples of the translation non-enabled device 108 may be any computing device running a conventional web browser 109. A translation enabled device 110 may be any device that includes a remote access web browser 111 that communicates with the co-browsing translator 106 at a remote access server 104. Such a remote access web browser 111 includes a client application (either native to the remote access web browser 111 or supplied as a plug-in/separate application on the translation enabled client device 110) that is capable of consuming state information contained in a state model 400, described below with regard to FIG. 4. Example devices include, but are not limited to wireless handheld devices (e.g., such as, for example, an IPHONE, a BLACKBERRY, an ANDROID device), a desktop/notebook personal computer, or a tablet device.

The remote access server 104 is connected to the network 112 and includes a co-browsing proxy 105 and the co-browsing translator 106. Together the co-browsing proxy 105 and the co-browsing translator 106 make up a co-browsing service 107. The co-browsing proxy 105 may be provided by a server remote access application to marshall requests and responses between the web browser service 103 and the client devices 108 and 110 to provide a synchronized view to participants in a co-browsing session of the web browser service 103.

The co-browsing translator 106 provides for receipt of requests from the remote access web browser 111 and refactoring (i.e., translation) of presentation data associated with responses from the web browser service 103 in accordance with a display area of the translation enabled device 110 to present a device-appropriate view. Presentation data is a rendered view of the visual state of the web browser service 103 that is displayed by the remote access web browser 111 on the translation enabled client device 110. In accordance with the present disclosure, the presentation data associated with, e.g., a response from the web browser service 103 may be refactored, i.e., translated, to accommodate the various possible display areas of the translation enabled device 110 that may participate in the co-browsing session. The co-browsing translator 106 operates based on display information contained in the state model 400, which is described below in greater detail with regard to FIG. 4.

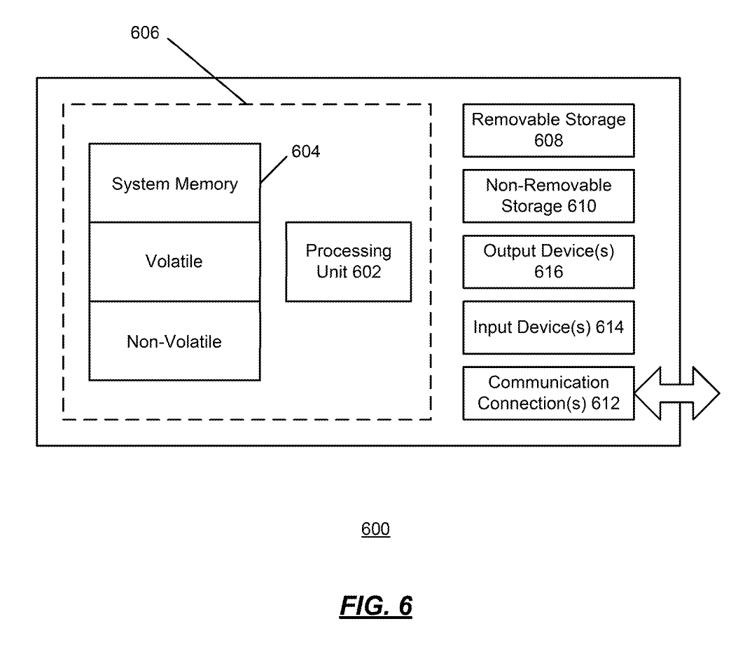

The application server 102 is connected to the network 112 and may be any server capable of executing applications, such as the web browser service 103. Although not shown, remote access server 104 may function as an application server, such that the web browser service 103 executes on the remote access server 104. The application server 102, remote access server 104, translation non-enabled device 108 and translation enabled device 110 may be implemented using hardware such as that shown in the general purpose computing device of FIG. 6. Software, applications (e.g., the web browser service 103, the co-browsing proxy 105, the co-browsing translator 106, the web browser 109 and remote access web browser 111) operating systems, etc. may be executed in memory and on the processer of the general purpose computing device of FIG. 6

In FIG. 1, the network 112 may be any type of network, for example, the Internet, Wi-Fi (IEEE 802.11x), WiMax (IEEE 802.16), Ethernet, 3G, 4G, etc.

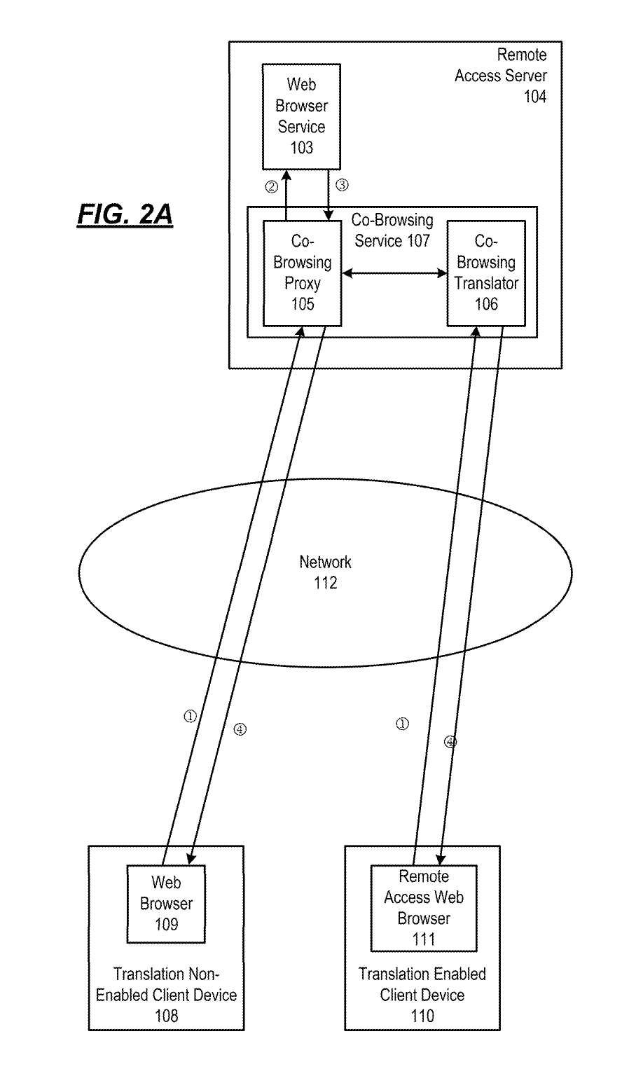

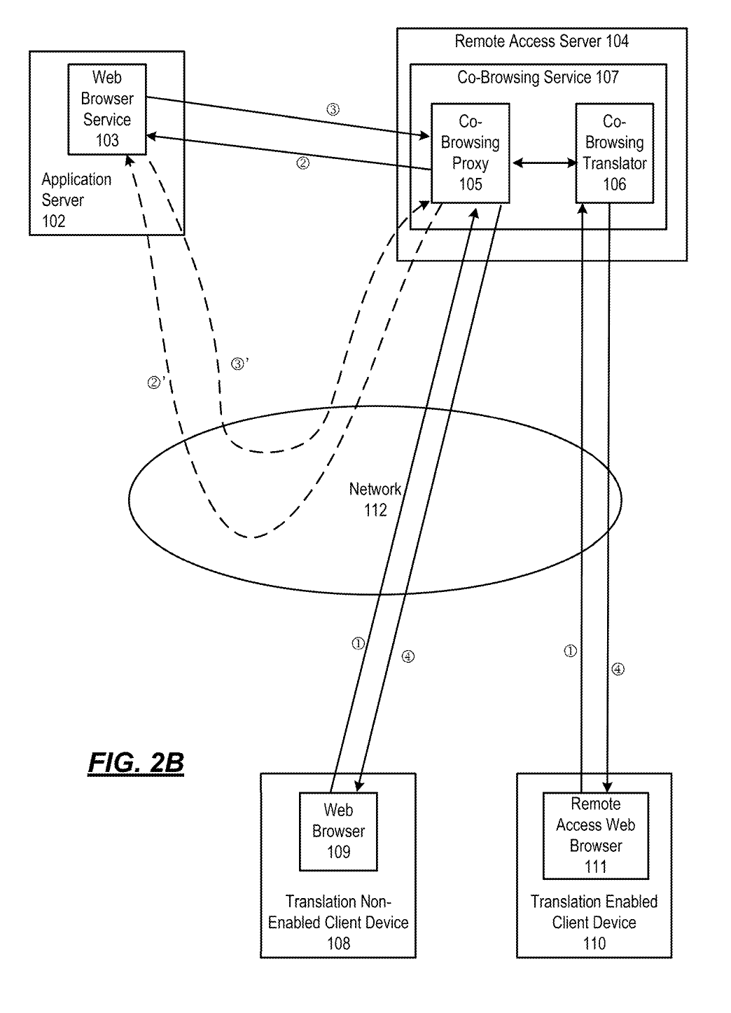

FIG. 2A illustrates a block diagram of exemplary data communication transferred between components in an implementation of the present disclosure to provide for co-browsing. FIG. 2A illustrates the web browser service 103 executing on the remote access server 104. The web browser service 103 may be simultaneously accessed by two (or more) participants in a co-browsing session where each participant accesses the web browser service 103 using, e.g., the web browser 109 of the translation non-enabled device 108 and the remote access web browser 111 of the translation enabled device 110.

As shown, a request for a resource (e.g., a document, media file, information, dynamically-generated query result, server-side script output) may be made by either (or both) of the web browser 109 and the remote access web browser 111 over the network 112. The request may be an HTTP request that is communicated to a Uniform Resource Locator (URL) associated with the co-browsing service 107 and, depending on the originating device, is directed directly to the co-browsing proxy 105 (for the translation non-enabled device 108) or directed to the co-browsing translator 106 (for the translation enabled device 110) (flow 1). In the later, the request may be forwarded to the co-browsing proxy 105. The web browser 109 and remote access web browser 111 may send a complete URL of the web browser service 103 in the request to the co-browsing service 107.

The co-browsing proxy 105, in turn, opens a connection (e.g., an HTTP connection) to the requested URL (i.e., the enumerated URL of the web browser service 103) and makes the request on behalf of the sending of device (flow 2). Alternatively, the connection may be a socket connection. As shown, the request is communicated over a direct connection between the co-browsing proxy 105 and the web browser service 103. Next, the web browser service 103 sends a response, which is communicated back to the co-browsing proxy 105 (flow 3). The response may be an HTTP response that includes the requested resource from flow 1. As shown, the response is communicated over a direct connection between the co-browsing proxy 105 and the web browser service 103.

Next, in accordance with the type of device (e.g., translation enabled or translation non-enabled), the response is either forwarded by the co-browsing proxy 105 to the translation non-enabled device 108 or by the co-browsing translator 106 to the translation enabled device 110 (flow 4). In the former instance, the response and the requested resource is provided to the web browser 109, where it is rendered for display. In the later instance, the response and the requested resource is processed by the co-browsing translator 106 to generate presentation data, as described above, which is appropriate for the display of the associated translation enabled device 110. As such, participants at each device will see a synchronized view of the web browser service 103.

FIG. 2B illustrates a block diagram of another exemplary data communication transferred between components in an implementation of the present disclosure to provide for co-browsing. FIG. 2B illustrates the web browser service 103 executing on the application server 102. The data flows 1-4 in FIG. 2B are the same as described above with regard to FIG. 2A, however, the request may be communicated over a direct connection between the co-browsing proxy 105 and the web browser service 103 (flow 2) or over the network 112 (flow 2′), and the response may be communicated back to the co-browsing proxy 105 either directly (flow 3) or over the network 112 (flow 3′).

With regard to FIGS. 2A and 2B, although only one of each type of device is shown, additional devices of each type may participate in the co-browsing session. As such, numerous devices may participate in the co-browsing session. Also, a request may be communicated by only one device, whereas the response is provided to all devices connected to the co-browsing session.

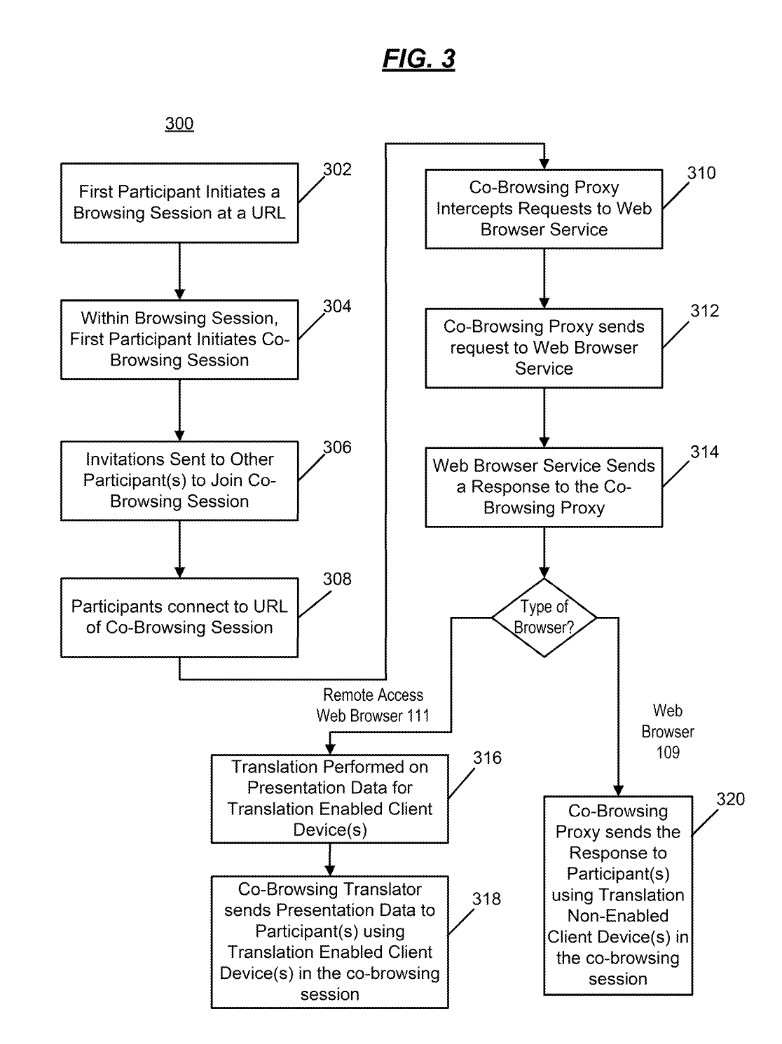

FIG. 3 is an operational flow diagram 300 of establishing a co-browsing session within the system 100 of the present disclosure. At 302, a browsing session is initiated at a URL by a first participant at a first client device 108 or 110. For example, using the web browser 109 or the remote access web browser 111, the first participant may connect to the web browser service 103 at a URL of the web browser service 103. Alternatively, the first participant may connect to the co-browsing service 107, which will communicate requests/response to and from the web browsing service 103. At 304, within the browsing session established at 302, the first participant initiates a co-browsing session. A menu item, radio button, control, etc., may be provided in a user interface of the web browser 109 or remote access web browser 111 to initiate the co-browsing session. The first participant may be prompted to enter identification of information of other participant(s) at a second or other client device 108 or 110 who will be joining the co-browsing session.

At 306, an invitation(s) is sent to the other participant(s) to join the co-browsing session. The invitation may be sent as a link to an enumerated URL associated with the co-browsing service 107. The link may be communicated in an email, SMS message, or other form of electronic communication. At 308, the invited additional participants join the co-browsing session at the enumerated URL. For example, invited participants may enter the enumerated URL into a respective web browser 109 or remote access web browser 111 of the invited participant(s) depending on the type of device used by the invited participant(s).

At 310, a request made by a participant to the web browser service 103 is proxied by the co-browsing proxy 105. The co-browsing proxy 105 intercepts requests from the web browser 109 and the remote access web browser 111 (via the co-browsing translator 106). At 312, the co-browsing proxy 105 sends the proxied request to the web browser service 103. The co-browsing proxy 105, after receiving the request, opens a connection to the enumerated URL of the web browser service 103 and makes a HTTP request to the web browser service 103.

At 314, the web browser service 103 sends a response to the co-browsing proxy 105. At 316, if the response is to be sent to a device running a remote access web browser 111, presentation data associated with the response is generated by the co-browsing translator 106. Here, the response may be translated to a device-appropriate view for display, as noted above. At 318, the presentation data associated with the response is communicated to each of the participant(s) utilizing translation enabled client devices 110 in the co-browsing session. At 320, if the response is to be communicated to a device running a web browser 109, the co-browsing proxy 105 sends the response directly to the web browser 109. As such, each type of device in the co-browsing session will present a synchronized view of the web browser service 103.

The operation of a co-browsing service 107 with the remote access web browser 111 is performed in cooperation with the state model 400, as illustrated in FIG. 4. The co-browsing service 107 may be implemented in PUREWEB, available from Calgary Scientific, Alberta, Canada. When executed, the co-browsing translator 106 and/or remote access web browser 111 updates the state model 400 in accordance with changes made by the web browser service 103 or user input data received in the remote access web browser 111.

Upon receipt of application data from web browser service 103, the co-browsing service 107 updates the state model 400 in accordance with the screen or application data, generates the presentation data in accordance with the updated state model 400, and provides the same to the. The state model 400 comprises an association of logical elements of the web browser service 103 with corresponding states of the web browser service 103, with the logical elements being in a hierarchical order. For example, the logical elements may be a screen, a menu, a submenu, a button, etc. that make up the web browser service 103 user interface. This enables the client device, for example, to natively display the logical elements. As such, a menu of the web browser service 103 that is presented on a mobile phone will look like a native menu of the mobile phone. Similarly, the menu of the web browser service 103 that is presented on desktop computer will look like a native menu of the desktop computer operating system.

The state model 400 may be determined such that the logical elements are associated with user interactions. For example, the logical elements of the web browser service 103 are determined such that the logical elements comprise transition elements with each transition element relating a change of the state model 400 to one of control data and representation data associated therewith.

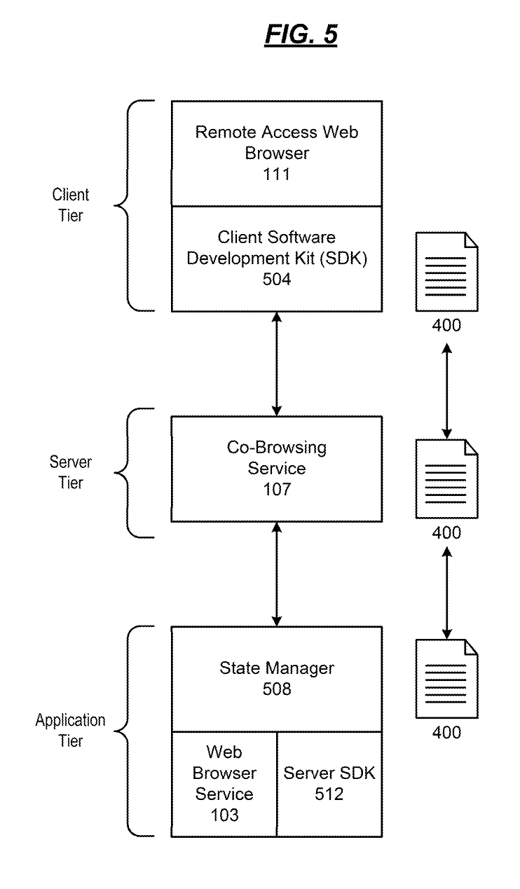

FIG. 5 illustrates aspects of the system 100 of FIG. 1 in greater detail. FIG. 5 illustrates the system 100 as having a tiered software stack. The remote access web browser 111 may sit on top of a client software development kit (SDK) 504 in a client tier. The client tier communicates to the co-browsing service 107 in a server tier. The server tier communicates to a state manager 508 sitting on top of the web browser service 103 and a server SDK 512 in an application tier. The state model 400 is communicated among the tiers and may be modified in any of the tiers.

Thus, the system 100 may be used to provide for collaborative browsing (co-browsing) of the web browser service 103. Additionally, a plurality of different participants can provide shared media, which may be simultaneously displayed by the participant devices. As noted above, the user interfaces of the present disclosure may be presented on any type of translation enabled device 110 participating within the co-browsing session based on information contained in the state model 400.

In some implementations, users co-browsing within the system 100 may be interacting with plural web browser services. Accordingly, the present disclosure may provide for recombination of the web browser services, where the web browser services are seamlessly integrated into the same user interface that is presented on each of the translation enabled devices participating in the co-browsing session. Recombination may be provided based on information contained in the state model 400. Thus, functionalities and controls associated with the web browser services may be combined within the same user interface.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for collaborative browsing within a session, comprising:
receiving a first connection to a web browser service from a first client device;
receiving an indication to begin a co-browsing session, the co-browsing session including at least the web browser service, the first client device and at least one second client device;
receiving subsequent connections to the web browser service from the client device and the second client device, the connections being made to the web browser service at an enumerated Uniform Resource Locator (URL) associated with the remote server;
receiving, at a co-browsing service, a request made to the web browser service from one of the first client device and the at least one second client device;
sending the request from the co-browsing service to the web browser service;
receiving, at the co-browsing service, a response to the request from the web browser service; and
communicating the response from the co-browsing service to each of the client device and the second client device.

2. The method of claim 1, further comprising synchronizing display information associated the response received from the web browser service at each of the first client device and the at least one second client device.

3. The method of claim 1, further comprising:
receiving display information associated with the response at a co-browsing translator associated with the co-browsing service;
refactoring the display information in accordance with a display area of at least one of the client device and the second client device participating in the co-browsing session; and
communicating refactored display information to the at least one of the client device and the second client device as the response.

4. The method of claim 1, further comprising:
connecting to a second web browser service at a second remote server;
receiving connections to the second web browser service from the client device and the second client device, the connections being made to the web browser service at a second enumerated Uniform Resource Locator (URL) associated with the remote server;
receiving, at the co-browsing service, a second request made to the second web browser service from one of the client device and the second client device;
sending the second request from the co-browsing service to the second web browser service;
receiving, at the co-browsing service, a second response to the second request from the second web browser service;
communicating the second response from the co-browsing service to each of the client device and the second client device; and
recombining display information associated with the web browser service and the second web browser service at each of the client device and the second client device.

5. The method of claim 1, further comprising:
proxying the request as an HTTP request at co-browsing proxy associated with the co-browsing service;
opening a connection from the co-browsing service to the enumerated URL of the web browser service; and
making the HTTP request to the web browser service.

6. A method of collaborative browsing of a web browser service by a plurality of web browsers in a collaborative browsing session, each of the plurality of web browsers being associated with a respective client device, the method comprising:
executing a co-browsing service on a remote access server;
receiving, at the co-browsing service, a request for a resource associated with the web browser service, the request being made from at least one web browser of the plurality of web browsers in the collaborative browsing session and being communicated to a URL of the co-browsing service;
forwarding the request from the collaborative browsing session to the web browser service;
receiving, at the co-browsing service, a response from the web browser service, the response including the resource; and
synchronizing, using the co-browsing service, a view of the web browser service at each of the plurality of web browsers such that each of the plurality of web browsers displays substantially a same view of the web browser service.

7. The method of claim 6, wherein the co-browsing service comprises a co-browsing proxy that intercepts the request and response and a co-browsing translator that translates presentation data associated with the web browser service in accordance with a resolution of display of a particular one respective client device.

8. The method of claim 7, further comprising performing translation of the presentation data using information contained in a state model that is communicated between the particular one respective client device and the co-browsing translator.

9. The method of claim 7, wherein one of the plurality of web browsers is a remote access web browser, the method further comprising:
receiving the request from the remote access web browser at the co-browsing translator;
forwarding the request to the co-browsing proxy to be communicated to the web browser service;
receiving the response at the co-browsing proxy;
refactoring a view associated with the response at the co-browsing translator to generate the presentation data; and
communicating the presentation data to the remote access web browser.

10. (canceled)

11. The method of claim 9, wherein the collaborative session comprises at least one remote access web browser and at least one non-remote access web browser, wherein refactoring is performed for the at least one remote access web browser, but not for the at least one non-remote access web browser.

12. The method of claim 6, wherein the co-browsing service intercepts Hypertext Transfer Protocol (HTTP) requests and responses from the plurality of web browsers and the web browsing service.

13. The method of claim 12, further comprising:
receiving, at the co-browsing service, a uniform resource locator (URL) in an HTTP request, the URL being associated with the web browser service;
opening a connection to the URL;
making the HTTP request; and
communicating an HTTP response to the HTTP request to the plurality of web browsers.

14. (canceled)

15. The method of claim 6, further comprising joining the plurality of web browsers in the collaborative browsing session at the co-browsing service.

16. (canceled)

17. (canceled)

18. (canceled)

19. (canceled)

20. (canceled)

21. A collaborative browsing service comprising:
a co-browsing proxy that marshall requests and responses between a web browser service and client devices in communication with the web browser service; and
a co-browsing translator that provides for refactoring of presentation data associated with the web browser service in accordance with a display area of a particular client device.

22. The collaborative browsing service of claim 21, wherein the co-browsing translator is communicatively connected to the co-browsing proxy, and wherein the co-browsing proxy is communicatively connected to the web browser service.

23. The collaborative browsing service of claim 21, further comprising a state model for communicating state information between the co-browsing translator and the particular client device.

24. (canceled)

25. A method for collaborative browsing within a session between a first client device and at least a second client device, comprising:
receiving connections at a co-browsing service from the first client device and the at least second client device, the co-browsing service comprising:
a co-browsing proxy that marshall requests and responses between a web browser service and client devices in communication with the web browser service; and
a co-browsing translator that provides for translating of presentation data associated with the web browser service in accordance with a display area of a particular client device, wherein the first client device or the at least second client device executing a conventional web browser is connected to the co-browsing proxy, and wherein the first client device or the at least second client device executing a remote access web browser is connected to the co-browsing translator;
receiving a connection at the co-browsing service from the first client device or at least second client device;
communicating, by the co-browsing service, a request from any of the first client device or the at least second client to the web service; and
communicating, by the co-browsing service, a response to the request from the web service to each of the first client and the at least second client.

26. The method of claim 25, the first client device initiating the collaborative browsing by activating a control in a user interface of the conventional web browser or remote access web browser.

27. The method of claim 25, further comprising synchronizing, using the co-browsing service, a view of the web browser service at the first client device and the at least a second client device.

28. The method of claim 25, further comprising performing the translating of the presentation data using information contained in a state model that is communicated between the first client device or the at least second client device and the co-browsing translator.

29. (canceled)
